(19) United States
(12) Patent Application Publication
(10) Pub. No.: US 2004/0200938 A1
(43) Pub. Date: Oct. 14, 2004

(54) Retainers for plastic trash bags

(76) Inventor: Joseph Forlivio, Yonkers, NY (US)

Correspondence Address: ABELMAN, FRAYNE & SCHWAB, 150 East 42nd Street, New York, NY, 10017-5612, US

(21) Appl. No.: 10/409,377

(22) Filed: Apr. 8, 2003

(51) Int. Cl. F21V 21/00; B65B 67/04

(52) U.S. Cl. 248/213.2; 248/101; 248/316.7

(57) ABSTRACT

A retainer holds a bag to be removably positioned in waste baskets, trash cans, supermarket bag dispensers, etc., with the bag having a body portion terminating in a pair of opposing loop-type handles, and the body portion of the bag being adapted and positioned for placement generally adjacent to a first interior surface portion of a rigid receiving receptacle. The retainer includes a generally horizontal central member, at least two opposing leg members, and an extension member. The opposing leg members depend from the central member, and the leg members are dimensioned and positioned for receiving a rim portion of the receptacle therebetween. The extension member extends from the central member in a direction opposite the leg members, with the extension member being dimensioned to receive the loop-type handle to retain the bag in a predetermined position and location, thereby suspending the bag generally adjacent to the receptacle.

### FIELD OF THE INVENTION

This invention relates to gripping devices, and in particular to a retainer for holding a bag, such as a plastic shopping bag, for use as a liner in a receptacle, such as a small kitchen trash can.

### BACKGROUND OF THE INVENTION

Bags, sacks and other containers are typically composed of flexible material, such as plastic, paper and the like. The bag can include a loop-type handle extending from the edge of the open end of the bag that allows a user to grasp and carry the bag.

If the bag is to be used to collect and remove household trash or garbage, the closed end is typically placed into a receptacle, such as a plastic trash can, and the edge of the open end of the bag is wrapped around the corresponding rim of the receptacle. In this arrangement, the bag is held open to receive waste articles, e.g., kitchen scraps, waste paper, garbage and the like.

For example, a conventional plastic grocery bag can be placed into a kitchen trash can, and when full, removed from the can and taken to an outdoor garbage can for pick-up by the sanitation department.

In accordance with the practices of the prior art, the bags are typically held on the rim of the receptacle by a friction fit. Such bags and receptacle arrangements are subject to the problem of the bag slipping off of the rim and falling into the receptacle. For example, as items are dropped into the bag, the weight of such items can overcome the force of the friction fit, dislodging the bag from the rim of the receptacle. This is particularly true if the bottom of the plastic bag is suspended above the bottom of the container when it is first installed.

It is therefore one object of this invention to provide a retainer that will securely suspend a flexible plastic bag, such as a standard grocery bag, to serve as a liner and a trash bag when positioned in a suitably sized trash can.

Another object of the invention is to provide a retainer for such bags which does not require repeated attachment and removal from the rim of a receptacle.

### BRIEF SUMMARY OF THE INVENTION

A retainer holds a bag to be removably positioned in waste baskets, trash cans, and the like, where the bag has a body portion terminating in a pair of opposing loop-type handles, and the body portion of the bag is adapted for placement adjacent to the interior of a rigid receiving receptacle. The retainer includes a generally horizontal central member, two opposing leg members, and an extension member. The opposing leg members depend from the central member, and the leg members are dimensioned and positioned for receiving a rim portion of the receptacle therebetween. The extension member extends from the central member in a direction opposite the leg members, with the extension member being dimensioned to receive the loop-type handle to retain the bag in a predetermined position and location, and to thereby suspend the bag in the interior of the receptacle.

The invention also comprehends a retainer having sufficient space between the legs where they are joined to the central member to accommodate an outwardly extending or tubular type rim on the receptacle.

The invention also includes a method of retaining a bag made of a flexible web and formed with opposing loop handles at the margin of the bag opening in an open position in a rigid receptacle having an opening defined by a rim, the circumference defined by the rim being approximately the same as that defined by the open end of the bag, the method comprising:

a) providing two retainers, each retainer comprising a generally horizontal central member; opposing leg members depending from the central member, the leg members being dimensioned and positioned for receiving a rim portion of the receptacle therebetween; and an extension member extending from the central member in a direction opposite the leg members, the extension member being dimensioned to receive one of the loop-type handles to retain the bag in a predetermined position and location, thereby suspending the bag in the receptacle;

b) mounting the retainers in opposing positions on the rim of the receptacle by securing the retainer legs adjacent the walls of the receptacle below the rim; and

c) placing the opposing loop handles over the extension members of the corresponding retainer, whereby the bag is suspended by the retainers in an open position.

### BRIEF DESCRIPTION OF THE DRAWINGS

Preferred embodiments of the invention are described hereinbelow with reference to the drawings wherein:

FIG. 1 is a top, side perspective view of the retainer in accordance with the present invention in use with a receptacle;

FIG. 2 is a side cross-sectional view of the retainer along lines 2-2 of FIG. 1;

FIG. 3 is a top cross-sectional view of the retainer along lines 3-3 of FIG. 1;

FIG. 4 is a top side perspective view of a first embodiment of the retainer shown in FIG. 1 in accordance with the present invention;

FIG. 5 is a top side perspective view of a second embodiment of the retainer in accordance with the present invention;

FIG. 6 is a top side perspective view of a third embodiment of the retainer in accordance with the present invention;

FIG. 7 is a front elevational view of the third embodiment of the retainer shown in FIG. 6 in accordance with the present invention;

FIG. 8 is a front elevational view of a fourth embodiment of the retainer in accordance with the present invention;

FIG. 9 is a top side perspective view of a fifth embodiment of the retainer in accordance with the present invention;

FIG. 10 is a top side perspective view of the fifth embodiment of the retainer shown in FIG. 9 in use with a receptacle;

FIG. 11 is a top side perspective view of the retainer in accordance with the present invention having an alternative use with a receptacle;

FIG. 12 is a cross-sectional side view of the retainer taken along lines 12-12 of FIG. 11; and

FIG. 13 is a cross-sectional view of the retainer along lines 13-13 of FIG. 11.

### DETAILED DESCRIPTION OF THE INVENTION

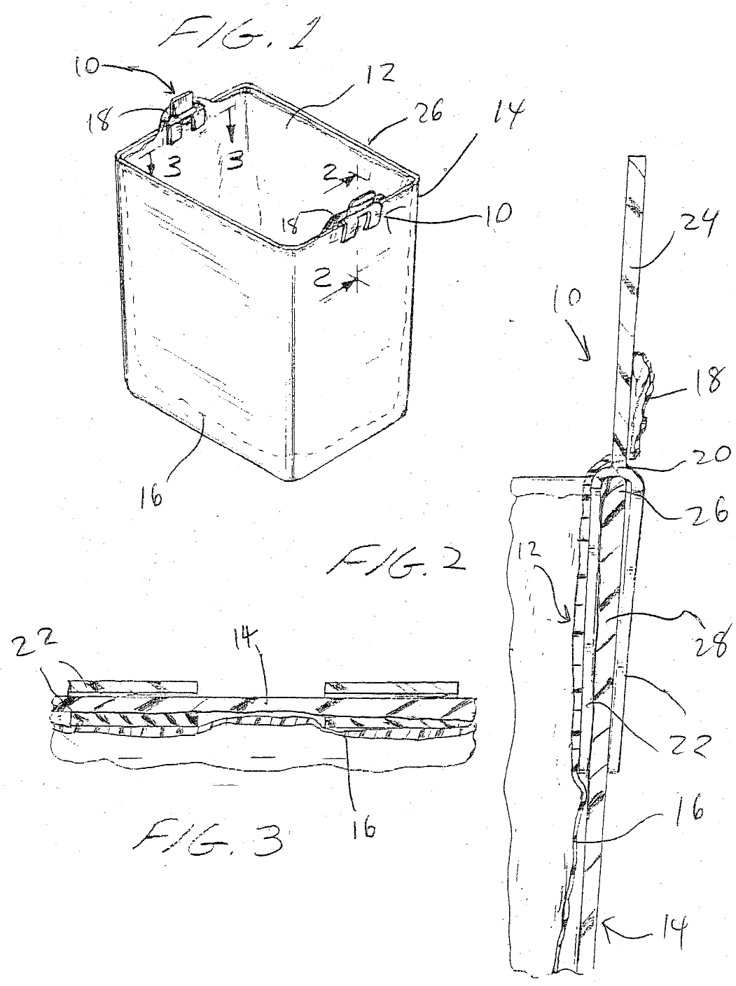

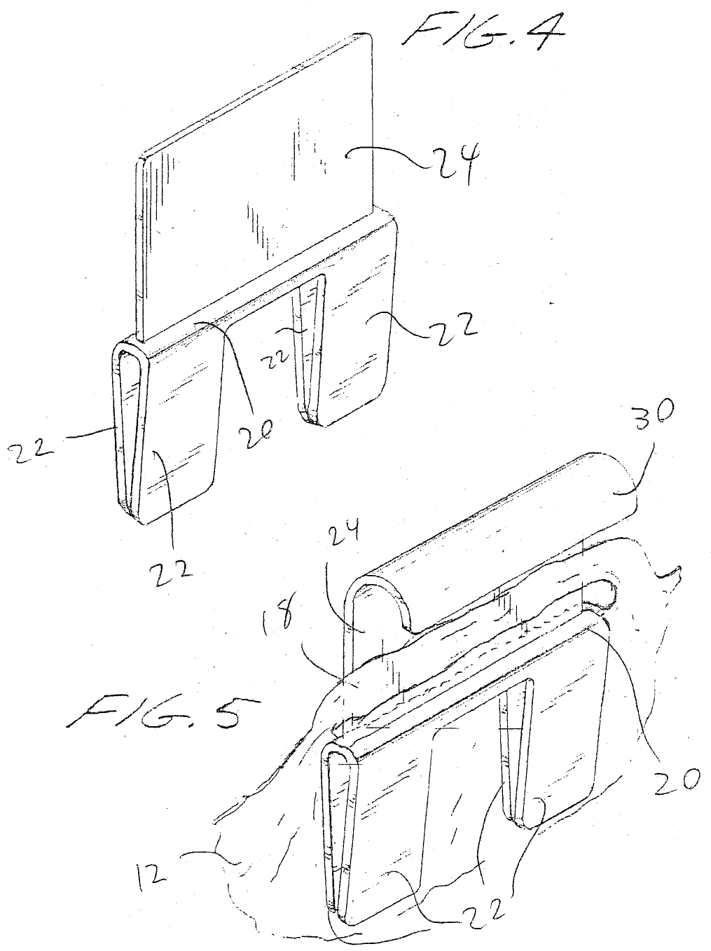

As shown in FIGS. 1-13, the invention is a retainer 10 for a bag 12, including plastic grocery bags or other flexible structures which are removably positioned in a receptacle 14 such as waste baskets, trash cans, and the like.

Referring in particular to FIGS. 1-3, the bag 12 has a body portion 16 terminating in a pair of opposing loop-type handles 18, with the body portion 16 of the bag 12 adapted and positioned for placement generally adjacent to a first interior surface portion of a rigid receiving receptacle 14.

Referring to FIG. 4, the retainer 10 is shown in greater detail and includes a generally horizontal central member 20, two opposing leg members 22, and an extension member 24. The retainer 10 can preferably be formed from injection molded plastic, or alternatively from molded rubber.

The two opposing leg members 22 depend from the central member 20, with the leg members 20 being dimensioned and positioned for receiving a rim portion 26 of the receptacle 14 therebetween. The extension member 24 extends from the central member 20 in a direction opposite the leg members 22, with the extension member 24 being dimensioned to receive a loop-type handle 18 to retain the bag 12 in a predetermined position and location, thereby suspending the bag 12 inside the receptacle 14.

The two opposing leg members 22 are composed of resilient material where the two opposing leg members 22 are biased toward the other, and the central member 20 preferably forms a living hinge to permit the relative movement of opposing leg members 22. Alternatively, the juncture between the leg members and the central member can be rigid or inflexible, and the legs themselves can be sufficiently resilient or flexible to be spread apart to slide over the upstanding rim of the receptacle.

In either event, the free ends of the opposing leg members 22 are manually moveable from a first proximate position to pass over the rim 26 of the receptacle 14 and contact the walls 28 of the receptacle 14 when mounted on the rim 26 of the receptacle 14.

In the first embodiment shown in FIGS. 1-4, the extension member 24 is generally planar and/or rectilinear. In a second embodiment of the retainer 10 shown in FIG. 5, the extension member 24 terminates in a downwardly turned end portion 30 to facilitate retaining the handle 18 by preventing any upward movement of the handle 18, due to movement of the bag 12, that might cause the handle 18 to slip up and over the extension member 24. Optionally, the downwardly turned end portion 30 serves as a handgrip to facilitate removing the retainer, e.g., for cleaning, or even for lifting the receptacle 14 held between the leg members 22 of the retainer.

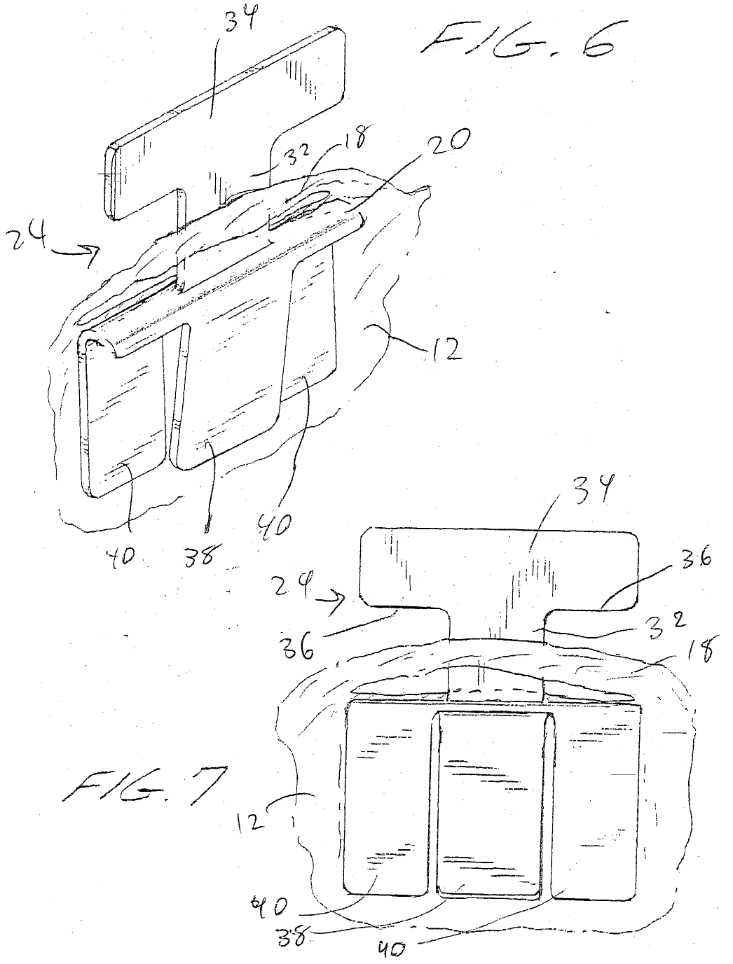

In a third embodiment shown in FIGS. 6-7, the extension member 24 is T-shaped, having a first portion 32 extending upward from the central member 20, and a second cross portion 34 above the first portion 32. The second portion 34 has lower edges 36 which facilitate retention of the handle 18 by preventing any upward movement of the handle 18, due to movement of the bag 12, that might cause the handle 18 to slip up and over the extension member 24.

A similar desirable result can be obtained by substituting a circular extension member having a central orifice (not shown), through which the loop handle of the bag could be passed and then extended over the perimeter of the circular extension member.

The opposing leg members 22 of the retainer 10 can be paired with a respective leg member, as shown in FIGS. 1-5. Alternatively, in the third embodiment shown in FIGS. 6-7, the opposing leg members 38 can be staggered and/or arranged in alternating positions on either side of the central member 20 along the longitudinal length of the central member 20.

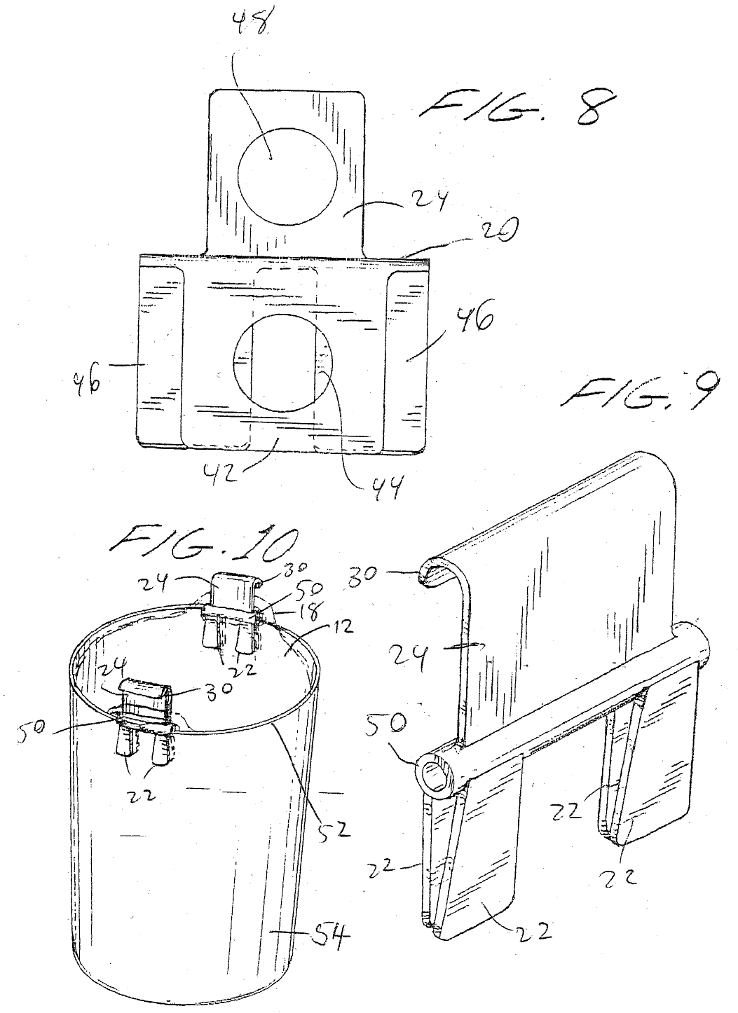

As shown in FIGS. 1-13, the opposing leg members 22 are generally planar. In a fourth embodiment of the retainer shown in FIG. 8, the generally planar leg member 42 includes an aperture 44, while the remaining leg members 46 do not. The aperture 44 can serve as finger holes for facilitating manipulation and/or lifting of the retainer by the user. Alternatively, the handle 18 of the bag 12 can pass through and/or be tied to the leg member 42 through the aperture 44.

In another alternative embodiment shown in FIG. 8, the extension member 24 can also include an aperture 48 to serve as finger hole for the user and/or to pass or tie the handle 18 of the bag 12 thereto.

In a fifth embodiment of the retainer shown in FIG. 9, the central member 50 has a generally circular cross-section, for example, formed by plastic molding or casting. In alternative embodiment, the central member 50 can be composed of flexible plastic, rubber, or other resilient materials, so that the central member 50 is axially flexible, allowing the central member 50 to generally conform to the shape of a curved rim 52 when mounted on a receptacle 54 having a curved horizontal cross-section such as a circular trash can.

In the embodiments shown in FIGS. 1-13, the two opposing leg members 22, 38, 40 are configured to maintain the central member 20, 50 proximate the rim 26, 52 of the respective receptacles 14, 54. The various leg members 22, 38, 40 can be arranged in different configurations for retaining the retainer 10 on the rim 26, 52. For example, in the third embodiment shown in FIGS. 6-7, two leg members 40 extend from one side of the central member 20 and a single leg member 38 extends from an opposing side of the central member 20. Similarly, in the fourth embodiment shown in FIG. 8, two leg members 46 extend from one side of the central member 20 and a single leg member 42 extends from an opposing side of the central member 20.

In addition, as shown in FIGS. 6-7, the various leg members can be arranged such that two leg members 40 are disposed at opposite ends of the central member 20 and the single member 38 is centrally disposed along the longitudinal length of the central member 20. Similarly, as shown in FIG. 8, two leg members 46 are disposed at opposite ends of the central member 20 and the single member 42 is centrally disposed along the longitudinal length of the central member 20.

Generally, throughout the various embodiments of the retainer shown in FIGS. 1-13, the free ends of the opposing leg members are disposed toward each other. For example, as shown in FIG. 4, the leg members 22 are biased towards each other. When not engaging a bag 12 or a receptacle, the opposing free ends of the leg members 22 can have sufficient biasing force to be in contact with each other as shown in FIG. 4.

As described herein with reference to FIGS. 1-3, the retainer 10 can be used with the receptacle 14 held between the opposing leg members 22, while the bag 12 is not held between the opposing leg members 22, but instead has the loop-type handle 18 extend over the extension member 24 of the retainer 10 to be retained by the extension member 24.

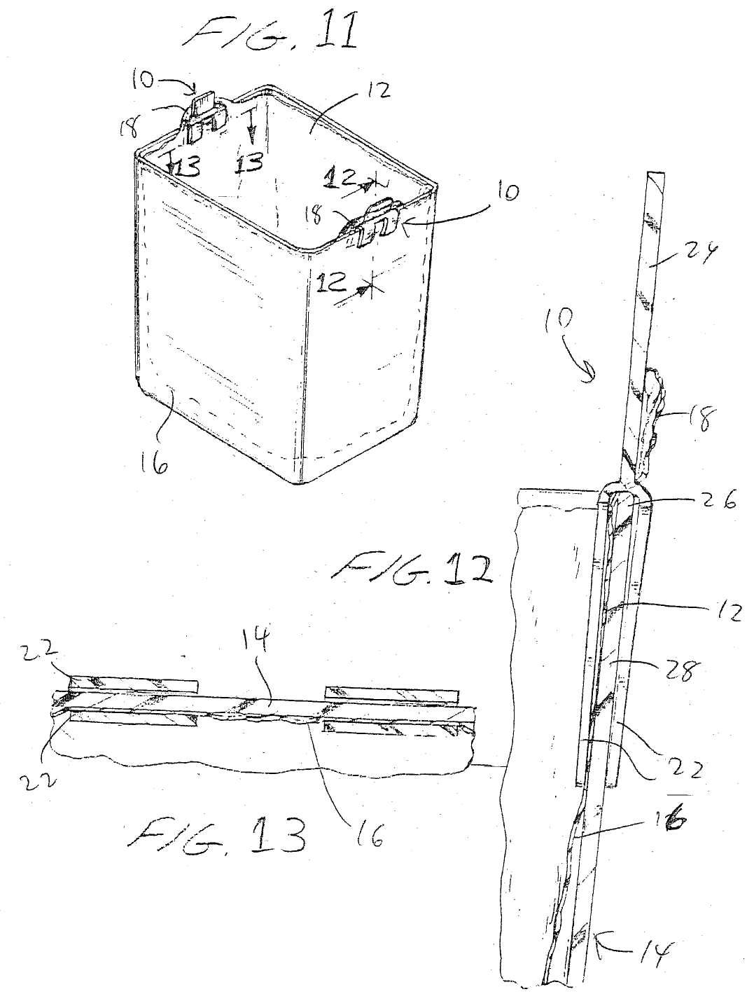

In an alternative embodiment shown in FIGS. 11-13, the retainer 10 can be used with both the bag 12 and the receptacle 14 held between the opposing leg members 22, whether or not the bag 12 includes the loop-type handles 18. Accordingly, the retainer 10 is versatile in that the retainer 10 can be used in the manner known in the prior art, especially if the bag 12 lacks the loop-type handles 18, or can be used in the manner described herein with the loop-type handles 18 retained by the extension member 24 for ease of removal from the retainer 10.

The invention also includes a method of retaining a bag 12 made of a flexible web and formed with opposing loop handles 18 at the margin of the bag opening in an open position in a rigid receptacle 14 having an opening defined by a rim 26, with the circumference defined by the rim 26 being approximately the same as that defined by the open end of the bag 12. The method comprises:

a) providing two retainers 10, with each retainer comprising

a generally horizontal central member 20;

two opposing leg members 22 depending from the central member 20, with the leg members 22 being dimensioned and positioned for receiving a rim portion 26 of the receptacle 14 therebetween; and

an extension member 24 extending from the central member 20 in a direction opposite the leg members 22, with the extension member 24 being dimensioned to receive the loop-type handle 18 to retain the bag 12 in a predetermined position and location, thereby suspending the bag 12 generally adjacent to the receptacle 14;

b) mounting the retainers 10 on opposite positions of the rim 26 of the receptacle 14 by securing the retainer legs 22 to the walls of the receptacle 14 below the rim 26; and

c) placing an opposing loop handle 18 over the extension member 24 of the corresponding retainer 10, whereby the bag 12 is suspended by the retainers 10 in an open position.

I claim:

1. A retainer for a bag, the bag having a body portion terminating in a pair of opposing loop-type handles, the body portion of the bag adapted and positioned for placement generally adjacent to a first interior surface portion of a rigid receiving receptacle, the retainer comprising:
a generally horizontal central member;
opposing leg members depending from said central member, said leg members being dimensioned and positioned for receiving a rim portion of the receptacle therebetween; and
an extension member extending from said central member in a direction opposite the leg members, the extension member being dimensioned to receive one of the loop-type handles to thereby retain said bag in a predetermined position and suspended in the receptacle.

2. The retainer of claim 1, wherein at least one of the opposing leg members is resiliently biased toward the other.

3. The retainer of claim 1, wherein the free ends of the opposing leg members are manually moveable from a first proximate position to pass over the rim of the receptacle and contact the walls of the receptacle when mounted on the rim of the receptacle.

4. The retainer of claim 1, wherein the extension member terminates in a downwardly turned end portion.

5. The retainer of claim 1, wherein the extension member is generally planar.

6. The retainer of claim 5, wherein the extension member is rectilinear.

7. The retainer of claim 5, wherein the extension member is T-shaped.

8. The retainer of claim 1, wherein at least one of the opposing leg members is generally planar.

9. The retainer of claim 8, wherein the generally planar leg member includes an aperture.

10. The retainer of claim 1, wherein the central member has a generally circular cross-section.

11. The retainer of claim 1, wherein the central member is sufficiently flexible to conform to the contour of a curved rim when mounted on the receptacle.

12. The retainer of claim 1, wherein the at least two opposing leg members are configured to maintain the central member proximate the rim of the receptacle.

13. The retainer of claim 1, wherein two leg members extend from one side of the central member and a single leg member extends from an opposing side of the central member.

14. The retainer of claim 13, wherein the two leg members are disposed at opposite ends of the central member and the single member is centrally disposed on the central member.

15. The retainer of claim 1, wherein the free ends of the opposing leg members are disposed toward each other.

16. The retainer of claim 15, wherein the opposing free ends are in contact with each other.

17. A method of retaining a bag in an open position in a rigid receptacle having an opening defined by a rim, the bag being formed of a flexible web and formed with opposing loop handles at the margin of the bag opening the circumference defined by the rim of the receptacle being approximately the same as that defined by the open end of the bag, the method comprising:
a) providing two retainers, each retainer comprising:
a generally horizontal central member;
at least two opposing leg members depending from said central member, said leg members being dimensioned and positioned for receiving a rim portion of the receptacle therebetween; and
an extension member extending from said central member in a direction opposite the leg members, the extension member being dimensioned to receive one of the loop handles to retain said bag in a predetermined position and suspending the bag in the receptacle;
b) mounting the retainers on opposite positions of the rim of the receptacle by securing the retainer legs to the walls of the receptacle below the rim; and
c) placing one of each of the opposing loop handles over the extension member of the corresponding retainer, whereby the bag is suspended by the retainers in an open position.

18. The method of claim 17, wherein the bag is a plastic grocery bag.

19. The method of claim 17, wherein the retainer is formed from an injection molded plastic.

20. The method of claim 17, wherein the retainer is molded rubber.

21. The method of claim 17, wherein a sidewall portion of the bag is positioned between the rim of the receptacle and the retainer.
